(19) United States
(12) Patent Application Publication
(10) Pub. No.: US 2005/0088706 A1
(43) Pub. Date: Apr. 28, 2005

(54) Scanner

(75) Inventor: Tsung-Te Lin, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/959,227

(22) Filed: Oct. 6, 2004

(30) Foreign Application Priority Data
Oct. 8, 2003 (TW) TW92218005

(51) Int. Cl. H04N 1/04

(52) U.S. Cl. 358/474; 358/497

(57) ABSTRACT

A scanner for scanning an object. The scanner comprises a platen, a scanning device, a contact element, a frame and a base. The object is placed on the platen. The scanning device scans the object by a belt driven device. The contact element is disposed between the platen and the scanning device. The base flexibly supports the scanning device toward the platen, providing thorough and regulated distance therebetween.

### BACKGROUND

The inventions relates to a scanner and in particular to a scanner with contact image sensor (CIS).

FIG. 1a shows a conventional contact image sensor (CIS) scanner, which includes an upper frame 11, a lower frame 12, a platen 13, a scan head 14, a track 15 and a driving mechanism 16. The upper frame 11 has an opening 111 therein in which the platen 13 is disposed. The scan head 14 is disposed between the upper frame 11 and the lower frame 12. A contact image sensor (not shown) is recessed in the scan head 14. The contact image sensor scans the object placed on the platen 13. The track 15 is disposed in the lower frame 12. The scan head 14 has a connecting portion 141 connected to the track 15. The driving mechanism 16 moves the scan head 14 along the track 15 completing the scan of the object.

FIG. 1b shows the structure of the scanner shown in FIG. 1a. In FIG. 1b, the connecting portion 141 is formed at the bottom of the scan head 14. Several rollers 142 are installed at the top of the scan head 14 to contact the platen 13. Meanwhile, the scan head 14 is connected to the driving mechanism 16 by a belt 161, moving the scan head 14 along the track 15.

It may be difficult to maintain a predetermined distance between the object and the contact image sensor. Any fluctuation in mechanical dimension or change in temperature can cause deformation in material and render mass production difficult.

### SUMMARY

Therefore, an object of the invention is to disclose a scanner that solves the above mentioned problem.

The scanner comprises a platen, a scanning device, a contact element, a frame and a base. An object is placed on the platen. The scanning device scans the object by a belt driven device. The contact element is disposed between the platen and the scanning device. The base moves on the frame, fluctuating to flexibly supports the scanning device so that the scanning device is pushed toward the platen.

The scanning device may comprise a carriage and a sensor, the sensor recessed in the carriage to scan the object, the carriage movably disposed under the platen, and the base flexibly supporting the carriage toward the platen. The base may comprise a body and an elastic member, the elastic member connected to the body, the body connected to the carriage, and the body supporting the carriage toward the platen by the elastic member. The elastic member may be a spring.

The body and the elastic member may comprise an integral elastic structure. The elastic structure may be plastic or may comprise a material with low coefficient of friction.

The base may further comprise an active portion, the base moving on the frame by the active portion. The active portion may comprise a roller along the frame or a slider on the frame.

The body, the elastic member and the active portion may comprise an integral elastic structure. The elastic structure may be a plastic structure or may comprise a material with low coefficient of friction.

The elastic member and the active portion may comprise an integral elastic structure. The elastic structure may be a plastic structure or may comprise a material with low coefficient of friction.

The scanner may further comprise a track disposed in the frame, guiding the scanning device moving along the axial direction of the track. The base may comprise a sliding groove slidably mounted over the track such that the scanning device moves along the track. The belt driven device connects the scanning device, driving the scanning device along the track.

The contact element may be a lubricating element.

The sensor mentioned above may be a contact image sensor (CIS).

### BRIEF DESCRIPTION OF THE DRAWINGS

The invention can be more fully understood by reading the subsequent detailed description in conjunction with the examples and references made to the accompanying drawings, wherein:

FIG. 1a is a schematic diagram of a conventional scanner;

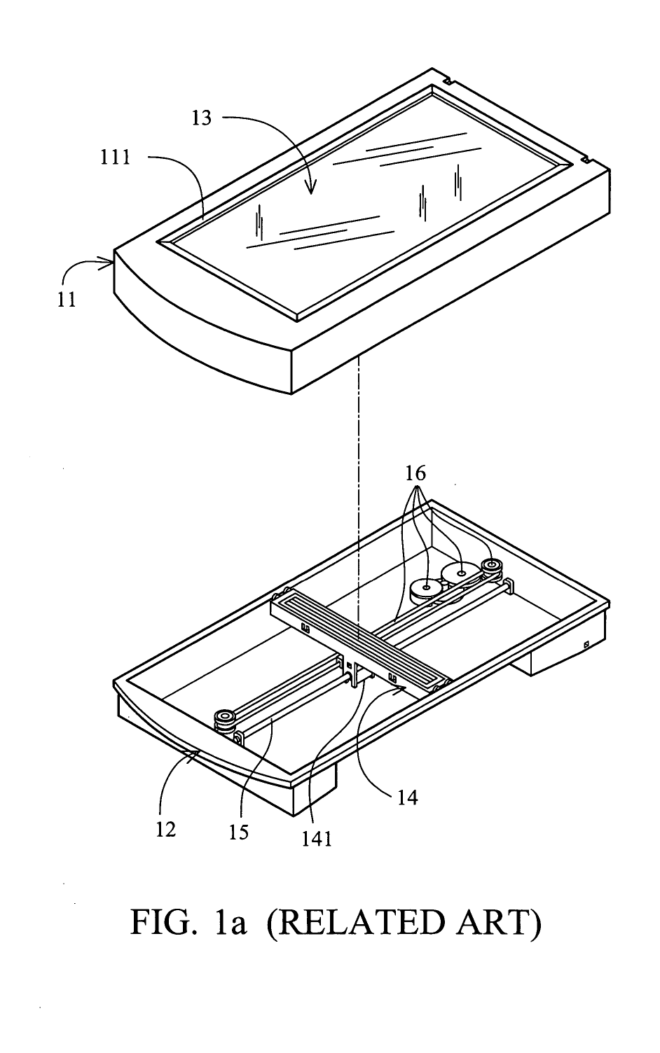

FIG. 1b is an enlarged view of the scanner according to FIG. 1a;

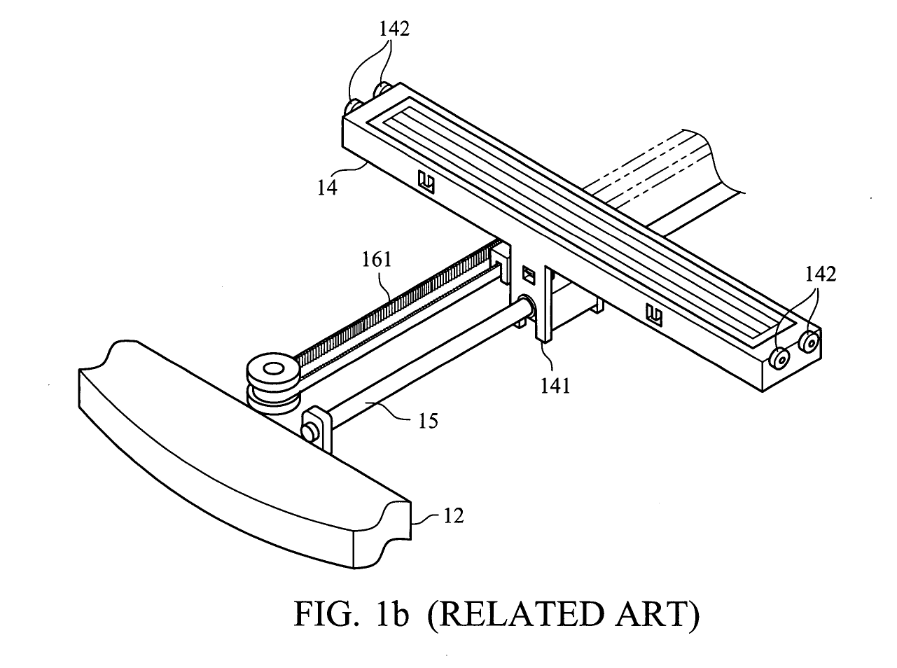

FIG. 2a is a stereogram of a scanner of a first embodiment;

FIG. 2b is an exploded perspective view of the scanner of the first embodiment;

FIG. 3a is a cross-section of the scanner of the first embodiment;

FIG. 3b is a diagram of a section of the scanner of the first embodiment;

FIG. 3c is a diagram of another section of the scanner of the first embodiment;

FIG. 4a is a diagram of the scanner of a second embodiment; and

FIG. 4b is a diagram of the scanner of a third embodiment.

### DETAILED DESCRIPTION

First Embodiment

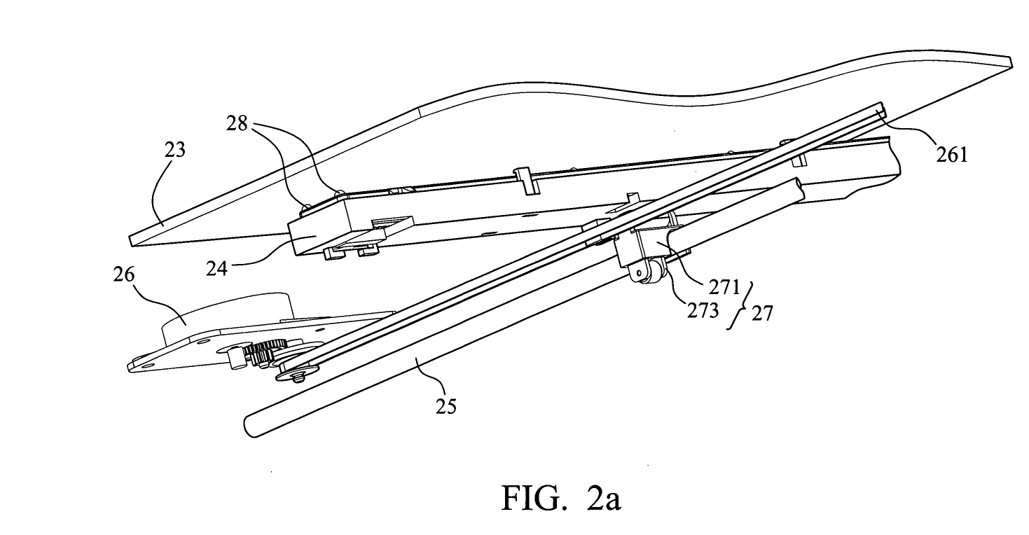

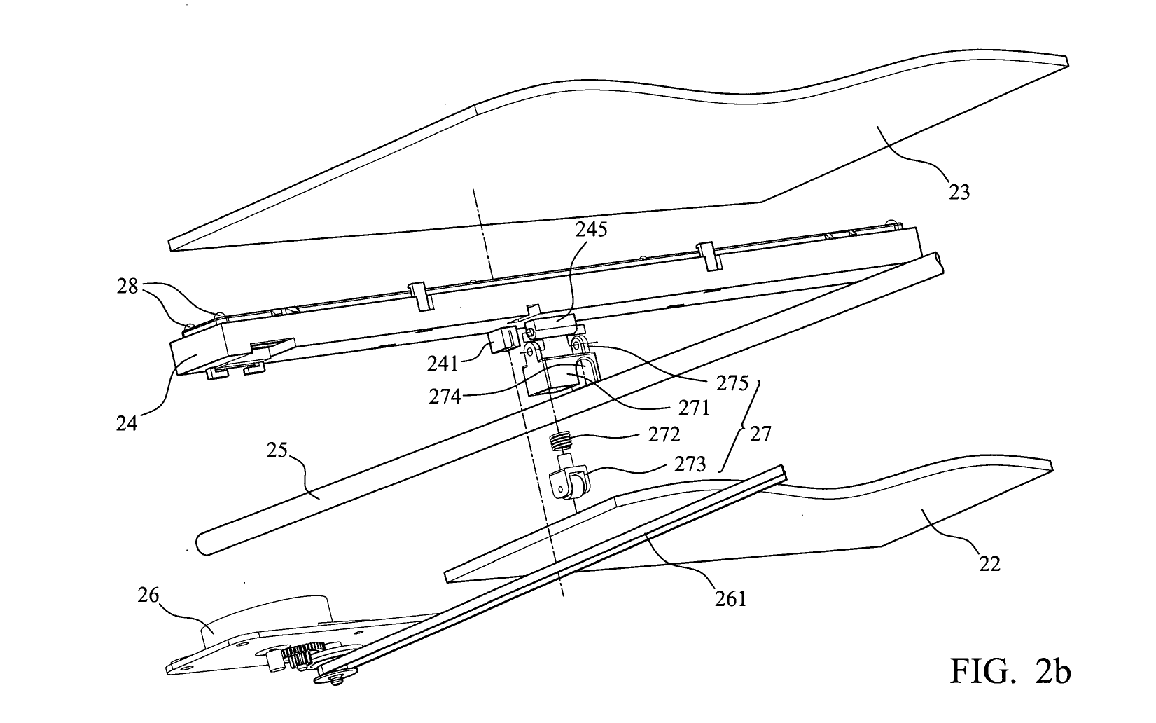

FIGS. 2a and 2b show a scanner of the first embodiment. Devices and elements common with a conventional scanner are omitted herefrom. The scanner of the invention comprises a frame 22, a platen 23, a scanning device, a track 25, a belt driven device 26 and a base 27. In this embodiment, the scanning device comprises a carriage 24 and a sensor (not shown). The sensor may be a contact image sensor (CIS).

An object such as a document or picture is disposed on the platen 23. The carriage 24 is disposed under the platen 23 and the sensor is received therein. The sensor scans the object by the platen 23. Contact elements 28 are disposed on the carriage 24, contacting the platen 23. The contact element 28 may be a lubricating element. The base 27 moves along the frame 22 and flexibly supports the carriage 24 toward the platen 23. The carriage 24 moves along the track 25 by a belt 261 of the belt driven device 26, enabling the sensor to scan the object comprehensively.

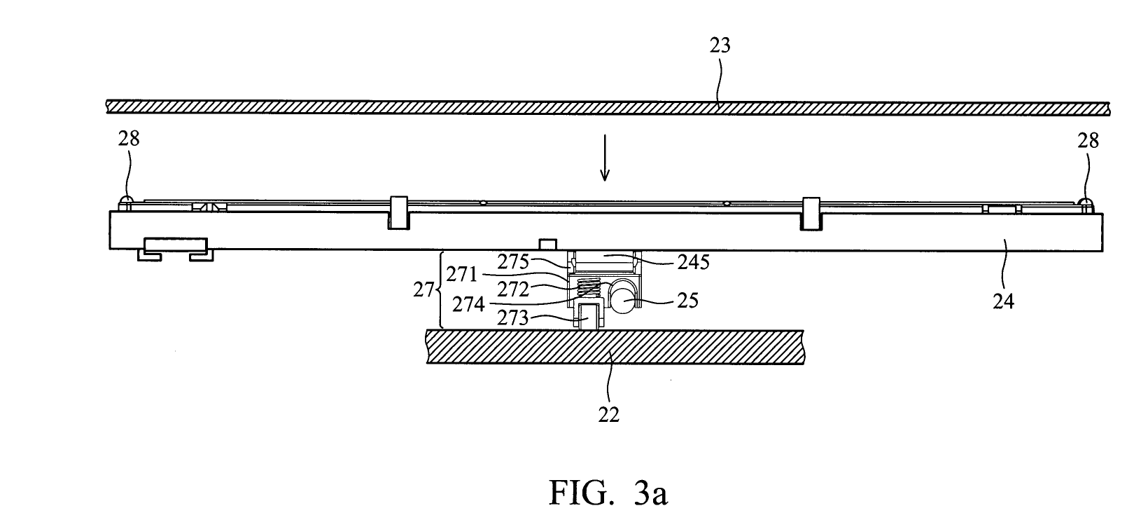

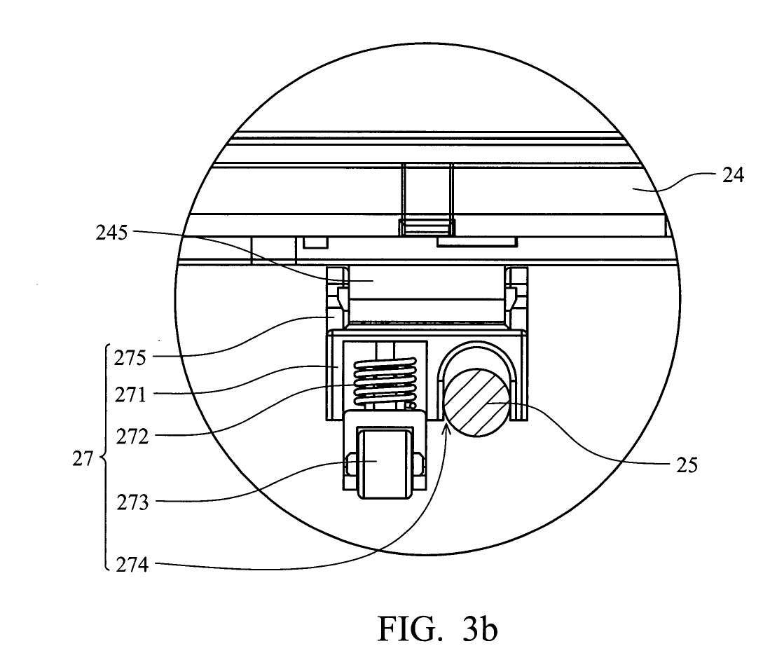

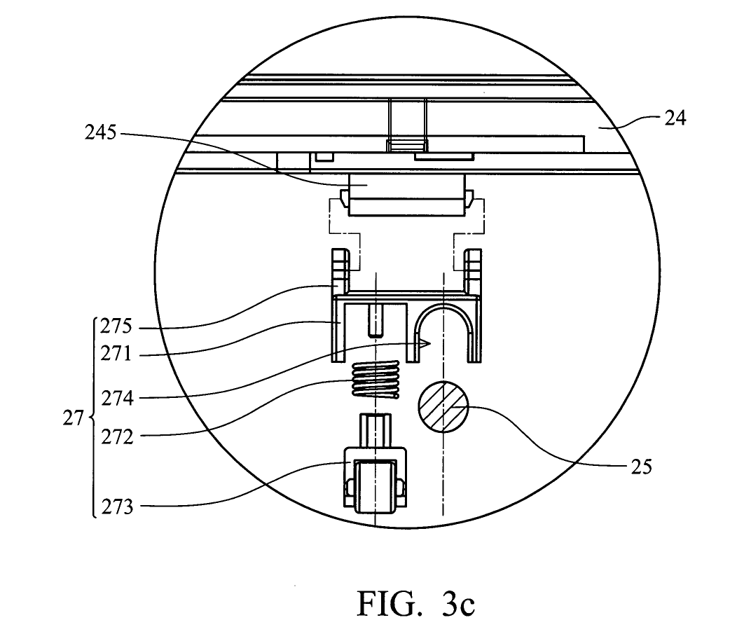

FIGS. 3a, 3b and 3c show a cross-section of the scanner of the first embodiment. The base 27 comprises a body 271, an elastic member 272, an active portion 273 and a sliding groove 274. In this embodiment, the elastic member 272 is a compression spring, and the active portion 273 is a roller. During assembly of the scanner, the body 271 of the base 27 is connected to the carriage 24. The elastic member 272 is disposed in the body 271 to connect the active portion 273. Meanwhile, the sliding groove 274 is movably mounted over the track 25 so that the base 27 is limited by the track 25. The base 27 can only flexibly move upward or downward but not leftward or rightward. Therefore, the carriage 24 is securely positioned. The active portion 273 of the base 27 contacts the frame 22. Namely, the active portion 273 moves on the inner surface of the frame 22.

After the platen 23 is connected to the scanner, the carriage 24 is supported by the base 27. The top of the contact element 28 is higher than the final assembled position of the platen 23. Therefore, when the platen 23 is installed in the direction shown by the arrow in FIG. 3a, the platen 23 pushes the contact element 28 on the carriage 24, deforming the elastic member 272 of the base 27. Resilient force thus pushes the carriage 24 toward the platen 23. Thereby, the distance between the carriage 24 and the platen 23 is secured during the scanning process. The object maintains in focus for the sensor, securing the optical quality. The belt driven device 26 continues to drive the carriage 24 and active portion 273 of the base 27, completing the scanning process.

In the aforementioned structure, the carriage 24 may pivot with the base 27. In this embodiment, the carriage 24 has a connecting portion 245, and the base 27 a protrusion 275. The pivot on the connecting portion 245 passes through the hole on the protrusion 275 so that the carriage 24 connects the base 27.

Second Embodiment

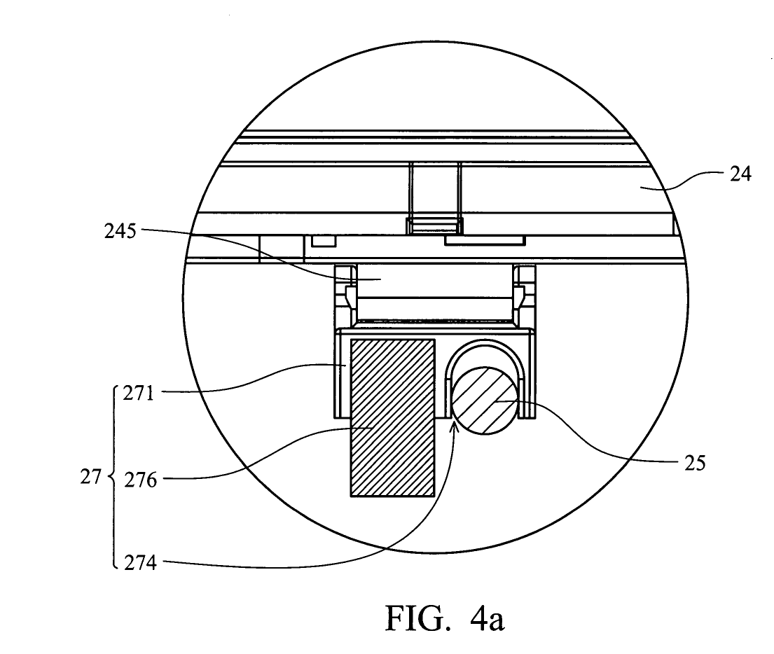

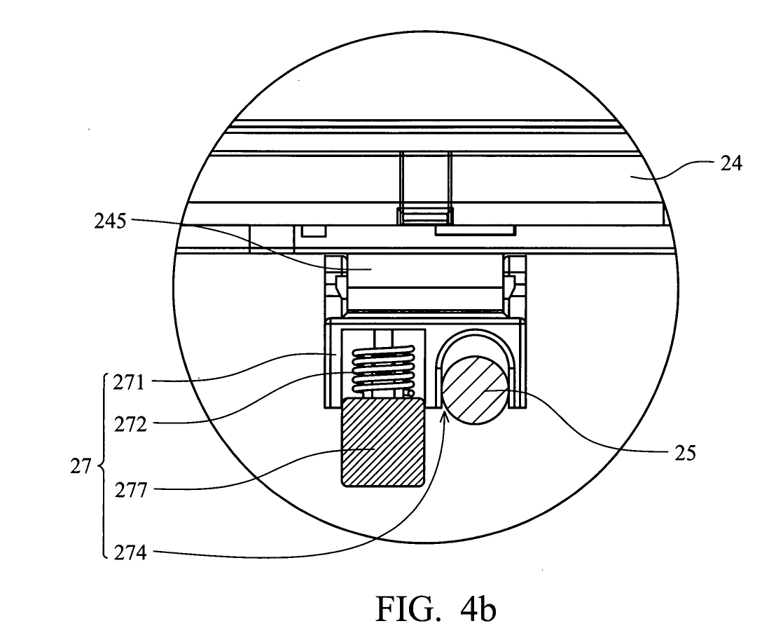

FIG. 4a shows a scanner of the second embodiment, similarities of which to the aforementioned structure are omitted. In this embodiment, the base 27 comprises a body 271, a sliding groove 274 and an elastic member 276. The body 271 and the elastic member 276 can be two separate structures or an integral elastic structure. The elastic structure may be plastic or comprise a material with low coefficient of friction. Similarly, the body 271 of the base 27 is connected to the carriage 24, and the elastic member 276 is partially disposed in the body 271. The sliding groove 274 is movably mounted over the track 25 so that the base 27 is limited by the track 25. The base 27 can only flexibly move upward or downward but not leftward or rightward. Therefore, the carriage 24 is securely positioned. The elastic member 276 of the base 27 contacts the frame 22 thereof on the inner surface.

After the platen 23 is installed on the scanner, the carriage 24 is supported by the base 27. The top of the contact element 28 is higher than the final assembled position of the platen 23. Therefore, during assembly, the platen 23 pushes the contact element 28 on the carriage 24, and deforms the elastic member 276 of the base 27, exerting resilient force pushing the carriage 24 toward the platen 23. The scanner of the invention thus secures the distance between the carriage 24 and the platen 23 during the scanning process. The object maintains focus of the sensor to secure optical quality. The belt driven device 26 continues to drive the carriage 24 and the elastic member 276 of the base 27, completing the scanning process.

The elastic member of this embodiment may comprise a combination of the elastic member and the active portion in the first embodiment. Namely, the elastic member and the active portion in the first embodiment may comprise an integral elastic structure to form the elastic member in the second embodiment. Furthermore, the body, the elastic member and the active portion in the first embodiment may comprise an integral elastic structure. The elastic structure mentioned above may be plastic or comprise a material with low coefficient of friction.

Third Embodiment

FIG. 4b shows a scanner of the third embodiment, similarities of which to the aforementioned structure are omitted. In this embodiment, the base 27 comprises a body 271, an elastic member 272, a sliding groove 274 and an active portion 277. In this embodiment, the elastic member 272 is a compression spring, and the active portion 277 is a slider formed by plastic or a material with low coefficient of friction. Similarly, the body 271 of the base 27 is connected to the carriage 24, and the elastic member 272 is disposed in the body 271 to connect the active portion 277. The sliding groove 274 moves on the track 25. The base 27 can only flexibly move upward or downward but not leftward or rightward. Therefore, the carriage 24 is securely positioned. The active portion 277 of the base 27 contacts the frame 22. Namely, the active portion 277 moves on the inner surface of the frame 22.

After the platen 23 is installed on the scanner, the carriage 24 is supported by the base 27. The top of the contact element 28 is higher than the final assembled position of the platen 23. Therefore, when assembling, the platen 23 pushes the contact element 28 on the carriage 24, and deforms the elastic member 272 of the base 27, exerting resilient force pushing the carriage 24 toward the platen 23. The scanner of the invention thus secures the distance between the carriage 24 and the platen 23 during the scanning process. The object maintains focus of the sensor to secure optical quality. The belt driven device 26 continues to drive the carriage 24 and the active portion 277 of the base 27, completing the scanning process.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A scanner for scanning an object, comprising:
a platen supporting the object;
a scanning device scanning the object by a belt driven device;
a contact element disposed between the platen and the scanning device;
a frame; and
a base moving on the frame, fluctuating to flexibly compel the scanning device toward the platen.

2. The scanner as claimed in claim 1, wherein the scanning device comprises a carriage and a sensor, the sensor recessed in the carriage, the carriage movably disposed under the platen, and the base flexibly supporting the carriage toward the platen.

3. The scanner as claimed in claim 2, wherein the base comprises a body and an elastic member connected to the body, the body connected to the carriage, and the body supporting the carriage toward the platen by the elastic member.

4. The scanner as claimed in claim 3, wherein the elastic member is a spring.

5. The scanner as claimed in claim 3, wherein the body and the elastic member comprise an integral elastic structure.

6. The scanner as claimed in claim 5, wherein the elastic structure is a plastic structure.

7. The scanner as claimed in claim 5, wherein the elastic structure comprises a material with low coefficient of friction.

8. The scanner as claimed in claim 3, wherein the base further comprises an active portion, by which the base moves along the frame.

9. The scanner as claimed in claim 8, wherein the active portion comprises a roller rolling on the frame.

10. The scanner as claimed in claim 8, wherein the active portion comprises a slider sliding on the frame.

11. The scanner as claimed in claim 10, wherein the body, the elastic member and the active portion comprise an integral elastic structure.

12. The scanner as claimed in claim 11, wherein the elastic structure is plastic.

13. The scanner as claimed in claim 11, wherein the elastic structure comprises a material with low coefficient of friction.

14. The scanner as claimed in claim 10, wherein the elastic member and the active portion comprise an integral elastic structure.

15. The scanner as claimed in claim 14, wherein the elastic structure is plastic.

16. The scanner as claimed in claim 14, wherein the elastic structure comprises a material with low coefficient of friction.

17. The scanner as claimed in claim 1, further comprising a track disposed in the frame, guiding the scanning device moving along the axial direction of the track.

18. The scanner as claimed in claim 17, wherein the base comprises a sliding groove slidably mounted over the track along which the scanning device moves.

19. The scanner as claimed in claim 1, wherein the contact element is a lubricating element.

20. The scanner as claimed in claim 2, wherein the sensor is a contact image sensor (CIS).
